(19) United States
(12) Patent Application Publication
(10) Pub. No.: US 2025/0226385 A1
(43) Pub. Date: Jul. 10, 2025

(54) ELECTRODE FOR AN ALL-SOLID-STATE BATTERY INCLUDING TWO TYPES OF CONDUCTIVE MATERIALS AND METHOD OF MANUFACTURING SAME

(71) Applicants: Hyundai Motor Company, Seoul (KR); Kia Corporation, Seoul (KR)

(72) Inventors: Dong Hyun Cho, Seoul (KR); Hong Suk Choi, Seoul (KR); Seon Hwa Kim, Seoul (KR); So Yeon Kim, Seoul (KR); Jae Seok Nam, Seoul (KR); Jae Min Lim, Seoul (KR); Hee Soo Kang, Seoul (KR)

(21) Appl. No.: 18/805,767

(22) Filed: Aug. 15, 2024

(30) Foreign Application Priority Data
Jan. 9, 2024 (KR) 10-2024-0003646

(51) Int. Cl. H01M 4/1391; H01M 4/131; H01M 4/36; H01M 4/525; H01M 4/62

(52) U.S. Cl. CPC H01M 4/1391; H01M 4/131; H01M 4/366; H01M 4/525; H01M 4/625

(57) ABSTRACT

Described are an electrode for an all-solid-state battery including two types of conductive materials and a method of manufacturing the same. The electrode includes a composite including an electrode active material and a spherical conductive material attached to the surface of the electrode active material, a solid electrolyte, and a linear conductive material.

### CROSS-REFERENCE TO RELATED APPLICATION

This application claims, under 35 U.S.C. § 119 (a), the benefit of Korean Patent Application No. 10-2024-0003646, filed on Jan. 9, 2024, the entire contents of which are incorporated herein by reference.

### BACKGROUND

### Technical Field

The present disclosure relates to an electrode for an all-solid-state battery including two types of conductive materials and a method of manufacturing the same.

### Background

An all-solid-state battery is configured to include a cathode, an anode, and a solid electrolyte layer. Among these components, the cathode and the anode are composed of a composite form composed of an active material, a solid electrolyte, a conductive material, a binder, etc. Unlike general lithium-ion batteries, all-solid-state batteries include a solid electrolyte component responsible for conduction of lithium ions, thereby reducing the volume ratio of materials contributing to electronic conduction. Accordingly, electronic conductivity of the cathode and the anode decreases. To address this issue, research is ongoing to enhance the electronic conductivity of the cathode and the anode.

Generally, a conductive material is added to improve the electronic conductivity of electrodes. Electronic conductivity is determined by unique characteristics of the conductive material, such as type and shape thereof, but from the perspective of the electrode structure, the shape of the conductive material is an important factor in determining the electronic conductivity of electrodes. Additionally, unlike lithium-ion batteries, in all-solid-state batteries, in consideration of high reactivity between the solid electrolyte and the conductive material, an appropriate amount of the conductive material has to be determined when designing electrodes.

Recent research results on lithium-ion batteries have reported that the electronic conductivity of electrodes can be enhanced by mixing a spherical conductive material that contributes to electronic conduction over a short distance in the electrode structure and a linear conductive material that contributes to electronic conduction over a relatively long distance. However, in cases in which such results are applied to all-solid-state batteries, when dispersibility of the conductive material in the electrodes is low, excess conductive material that does not contribute to electronic conduction is generated, and the output characteristics are lowered due to reaction between the excess conductive material and the solid electrolyte. Therefore, in all-solid-state batteries, it is important to increase the dispersibility of a conductive material and decrease the amount of the conductive material that does not contribute to electronic conduction.

### SUMMARY

An object of the present disclosure is to provide an electrode for an all-solid-state battery with excellent dispersibility of a conductive material and a method of manufacturing the same.

Another object of the present disclosure is to provide an electrode for an all-solid-state battery with a small amount of excess conductive material and a method of manufacturing the same.

The objects of the present disclosure are not limited to the foregoing. The objects of the present disclosure will be able to be clearly understood through the following description and to be realized by the means described in the claims and combinations thereof.

An exemplary embodiment of the present disclosure provides an electrode for an all-solid-state battery, including a composite containing an electrode active material and a spherical conductive material associated with (e.g. attached to a surface of) the electrode active material, a solid electrolyte, and a linear conductive material.

The composite may satisfy Equation 1 below.

$$1 < ( a \times b ) / ( c \times d ) < 2.8 \qquad [ Equation 1 ]$$

In Equation 1, a is a specific surface area [m²/g] of the spherical conductive material, b is an amount [wt %] of the spherical conductive material in the electrode, c is a specific surface area [m²/g] of the electrode active material, and d is an amount [wt %] of the electrode active material in the electrode.

The electrode active material may include a cathode active material or an anode active material.

The cathode active material may include a lithium transition metal oxide.

The cathode active material may be coated with an alkali metal oxide.

The anode active material is a composite of the carbon active material and the metal active material.

The carbon active material may include graphite.

The metal active material may include indium (In), aluminum (AI), silicon (Si), tin (Sn), or an alloy containing at least one thereof.

The solid electrolyte may include a sulfide-based solid electrolyte.

The linear conductive material may electrically connect any one composite to another adjacent composite, any one composite to any one solid electrolyte, and any one solid electrolyte to another adjacent solid electrolyte.

The electrode may include about 40 wt % to about 70 wt % of the electrode active material, about 1 wt % to about 10 wt % of the spherical conductive material, about 20 wt % to about 50 wt % of the solid electrolyte, and about 1 wt % to about 10 wt % of the linear conductive material.

Another embodiment of the present disclosure provides a method of manufacturing an electrode for an all-solid-state battery, including manufacturing a composite containing an electrode active material and a spherical conductive material attached to a surface of the electrode active material by mixing the electrode active material and the spherical conductive material, preparing a starting material by mixing the composite, a solid electrolyte, and a linear conductive material, and forming an electrode using the starting material.

Manufacturing the composite may include manufacturing the composite by mixing the electrode active material and the spherical conductive material using a resonance vibration mixer.

Manufacturing the composite may include applying a resonance vibration frequency ranging from greater than about 0 Hz to less than about 100 Hz to the electrode active material and the spherical conductive material.

Manufacturing the composite may include mixing the electrode active material and the spherical conductive material by applying a gravitational acceleration of about 20G to about 80G thereto.

Manufacturing the composite may include mixing the electrode active material and the spherical conductive material by applying gravitational acceleration thereto for a period of time ranging from greater than about 2 minutes to less than about 20 minutes.

A term “all-solid-state battery” as used herein includes a rechargeable secondary battery that includes an electrolyte in a solid state transferring ions between the electrodes of the battery.

In further aspects, vehicles are provided that comprise an all-solid-state battery as disclosed herein.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows an all-solid-state battery according to the present disclosure;

FIG. 2 shows the internal structure of an electrode according to the present disclosure;

FIG. 3 shows a composite according to the present disclosure;

FIG. 4 shows an example of a resonance vibration mixing process;

FIG. 5 shows a scanning electron microscope (SEM) image of an anode active material used in Preparation Example 1;

FIG. 6 shows an SEM image of a composite according to Preparation Example 1;

FIG. 7 shows transmission electron microscope/energy-dispersive X-ray spectroscopy (TEM-EDS) images of the composite according to Preparation Example 1;

FIG. 8 shows an SEM image of the anode of an all-solid-state battery according to Example 1;

FIG. 9 shows an SEM image of the anode of an all-solid-state battery according to Comparative Example 1;

FIG. 10 shows initial performance of the all-solid-state batteries according to Example 1 and Comparative Example 1;

FIG. 11 shows an SEM image of a composite according to Comparative Example 3;

FIG. 12 shows an SEM image of a composite according to Example 1;

FIG. 13 shows an SEM image of a composite according to Comparative Example 2;

FIG. 14 shows initial performance of the all-solid-state batteries according to Examples 1 to 3, Comparative Example 2, and Comparative Example 3; and

FIG. 15 shows capacity retention of the all-solid-state batteries according to Examples 1 to 3, Comparative Examples 2, and Comparative Examples 3.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

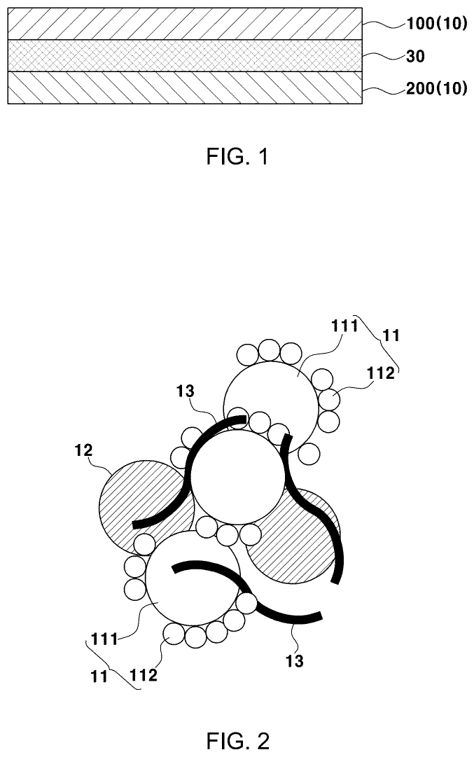

FIG. 1 shows an all-solid-state battery according to the present disclosure. The all-solid-state battery may include a pair of electrodes 10 and a solid electrolyte layer 20 disposed between the electrodes 10.

The electrodes 10 may include a cathode 100 and an anode 200. Hereinafter, the electrode 10 may refer to a cathode 100 and/or an anode 200, and those skilled in the art will be able to clearly understand the meaning thereof in consideration of the context.

FIG. 2 shows the internal structure of the electrode 10 according to the present disclosure. The electrode 10 may include a composite 11, a solid electrolyte 12, and a linear conductive material 13.

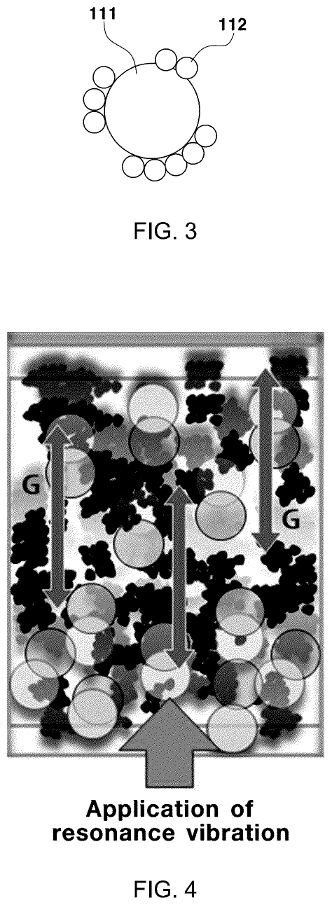

FIG. 3 shows the composite 11 according to the present disclosure. The composite 11 may include an electrode active material 111 and a spherical conductive material 112 attached to the surface of the electrode active material 111.

In the present disclosure, the spherical conductive material 112, which is favorable for short-distance electronic conduction, may be attached to the surface of the electrode active material 111 using a resonance vibration mixer, as will be described later, and the linear conductive material 13, which is favorable for long-distance electronic conduction, may be mixed with the composite 11 and the solid electrolyte 12, thus minimizing excess conductive material and preventing electronic conductivity in the electrode 10 from deteriorating.

Also, in the present disclosure, the spherical conductive material 112 may be provided in a form attached to the electrode active material 111, thus increasing dispersibility by decreasing the total amount of the conductive material in the electrode 10, thereby suppressing side-reaction between the spherical conductive material 112 and/or the linear conductive material 13 and the solid electrolyte 12.

Referring to FIG. 3, the spherical conductive material 112 may be attached in a powder state to the surface of the electrode active material 111. The fact that the spherical conductive material 112 is attached or positioned in a powder state means that it does not form a layer that completely covers the surface of the electrode active material 111, but rather is in contact with the surface of the electrode active material 111 while maintaining the particle shape thereof. When the spherical conductive material 112 covers the surface of the electrode active material 111 in the form of a coating layer, it may hinder the movement of lithium ions. Therefore, the composite 11 according to the present disclosure must be distinguished from a core-shell-type material.

Meanwhile, the spherical conductive material 112 may be strongly attached to the surface of the electrode active material 111. When mixing the spherical conductive material 112 and the electrode active material 111 in a resonance vibration manner, as will be described later, the spherical conductive material 112 may be prevented from easily separating from the electrode active material 111.

The electrode active material 111 may include a cathode active material or an anode active material.

The cathode active material may include a lithium transition metal oxide capable of storing and releasing lithium. Examples of the cathode active material may include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-including active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (in which M is at least one selected from among Al, Mg, Co, Fe, Ni, and Zn, 0<x+y<2), lithium titanate such as Li₄Ti₅O₁₂, and the like.

The cathode active material may be coated with an alkali metal oxide.

The alkali metal oxide may include an alkali metal element, a transition metal element, and a substitution element.

The alkali metal element may include at least one selected from the group consisting of lithium (Li), sodium (Na), potassium (K), and combinations thereof. Preferably, the alkali metal element includes lithium (Li).

The transition metal element may include any metal contained in alkali metal oxides commonly used in the technical field to which the present disclosure belongs. For example, the transition metal element may include at least one selected from the group consisting of niobium (Nb), tantalum (Ta), zirconium (Zr), and combinations thereof.

For example, a carbon active material or a metal active material may be used without particular limitation.

The carbon active material may include graphite such as natural graphite, artificial graphite, mesocarbon microbeads, highly oriented pyrolytic graphite, etc., or amorphous carbon such as hard carbon and soft carbon.

The metal active material may include indium (In), aluminum (Al), silicon (Si), tin (Sn), or an alloy containing at least one thereof.

The anode active material may be a composite of the carbon active material and the metal active material. For example, the surface of the carbon active material may be coated with the metal active material, or the surface of the metal active material may be coated with the carbon active material.

The particle size D50 of the cathode active material is not particularly limited, and may be, for example, 1 μm to 20 μm.

The spherical conductive material 112 may include at least one selected from the group consisting of carbon black, graphene, graphene oxide, and combinations thereof.

The particle size D50 of the spherical conductive material 112 is not particularly limited, and may be, for example, 10 nm to 500 nm.

The composite 11 may satisfy Equation 1 below.

1<(a×b)/(c×d)<2.8 [Equation 1]

In Equation 1, a may represent the specific surface area [m²/g] of the spherical conductive material 112, b may represent the amount [wt %] of the spherical conductive material 112 in the electrode 10, c may represent the specific surface area [m²/g] of the electrode active material 111, and d may represent the amount [wt %] of the electrode active material 111 in the electrode 10. The specific surface area may be measured by adsorbing an inert gas such as helium, nitrogen, etc. to the sample at a low temperature using a BET measuring device. When the composite 11 satisfies Equation 1, the amount of excess conductive material in the electrode may decrease, and the spherical conductive material 112 may be attached well to the surface of the electrode active material 111.

If the value of (a×b)/(c×d) of the composite 11 is 1 or less, the spherical conductive material 112 may not be attached to the surface of the electrode active material 111, and thus the electronic conductivity of the electrode 10 may be lowered relative to the amount of the conductive material that is added. On the other hand, if the value of (a×b)/(c×d) of the composite 11 is 2.8 or more, the spherical conductive material 112 may be excessively attached to the surface of the electrode active material 111, and thus the spherical conductive material 112 may aggregate, generating excess conductive material.

The specific surface area of the electrode active material 111 is not particularly limited, and may be, for example, 2 m²/g to 10 m²/g. The amount of the electrode active material 111 in the electrode 10 may be 40 wt % to 70 wt %.

The specific surface area of the spherical conductive material 112 is not particularly limited, and may be, for example, 15 m²/g to 70 m²/g. The amount of the spherical conductive material 112 in the electrode 10 may be 1 wt % to 10 wt %.

The solid electrolyte 12 may be a material responsible for conducting lithium ions in the electrode 10. The solid electrolyte 12 may include any material having lithium ion conductivity, and may include, for example, at least one selected from the group consisting of an oxide-based solid electrolyte, a sulfide-based solid electrolyte, and combinations thereof. Also, the solid electrolyte 12 may be crystalline, amorphous, or in a mixed state thereof.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers, and M is any one selected from among P, Si, Ge, B, Al, Ga, and In), Li₁₀GeP₂S₁₂, and the like.

Preferably, the solid electrolyte 12 may include a sulfide-based solid electrolyte having an argyrodite crystal structure. The sulfide-based solid electrolyte having the argyrodite crystal structure may include at least one selected from the group consisting of Li_{7-y}PS_{6-y}Ha_{y} (in which Ha includes Cl, Br, or I and y satisfies 0<y≤2), Li_{7-z}PS_{6-z}(Ha1_{1-b}Ha2_{b})_{z} (in which Ha1 and Ha2 are different from each other, each independently includes Cl, Br or I, and b and z satisfy 0<b<1 and 0<z≤2), and combinations thereof.

The linear conductive material 13 may serve to electrically connect various components within the battery structure. It facilitates electrical connections between one composite 11 and another adjacent composite 11, between one composite 11 and any one solid electrolyte 12, and between any one solid electrolyte 12 and another adjacent solid electrolyte 12.

The linear conductive material 13 may include e.g. at least one selected from the group consisting of carbon nanotubes, carbon nanofiber, vapor grown carbon fiber, and combinations thereof.

The diameter and length of the linear conductive material 13 are not particularly limited. For example, the diameter may range from 100 nm to 300 nm, and the length may vary from 2 μm to 10 μm.

The electrode 10 may include 40 wt % to 70 wt % of the electrode active material 111, 1 wt % to 10 wt % of the spherical conductive material 112, 20 wt % to 50 wt % of the solid electrolyte 12, and 1 wt % to 10 wt % of the linear conductive material 113.

A linear conductive materials are referred to herein may include materials whose conductivity remains relatively constant over a wide range of voltages and currents. That is, in certain aspects, the resistance of a linear conductive material does not change significantly (e.g. changes less than 50, 40, 30, 20, 10, or 5 percent or less) with variations in voltage or current. In certain aspects, carbon nanotubes or carbon nanofibers may be used as a linear conductive material. Additional suitable and preferred materials may be determined empirically e.g. by testing the material to determine or confirm that its resistance does not changes significantly with variations in voltage or current.

The electrode 10 may further include a binder. Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder may exist in a granular or linear form in the electrode 10.

The method of manufacturing the electrode 10 according to the present disclosure may include manufacturing a composite 11 with a spherical conductive material 112 attached to the surface of an electrode active material 111 by mixing the electrode active material 111 and the spherical conductive material 112, preparing a starting material including the composite 11, a solid electrolyte 12, and a linear conductive material 13, and forming an electrode 10 using the starting material.

Manufacturing the composite 11 may include mixing the electrode active material 111 and the spherical conductive material 112 using a resonance vibration mixer as shown in FIG. 4 to obtain the composite 11.

FIG. 4 shows an example of a resonance vibration mixing process. Resonant vibration mixing may include applying acoustic energy and vibration energy to a sample for mixing. As shown in FIG. 4, when the sample undergoes vertical vibration movement, Faraday waves appear by applying subharmonics to the sample, thereby conferring strong shear force and collision force to the sample.

Specifically, manufacturing the composite 11 may include applying a resonance vibration frequency ranging from greater than 0 Hz to less than 100 Hz to the electrode active material 111 and the spherical conductive material 112. At the same time, manufacturing the composite 11 may include applying a gravitational acceleration of 20 G to 80 G to the electrode active material 111 and the spherical conductive material 112 for a period of time ranging from greater than 2 minutes to less than 20 minutes.

The starting material may be obtained by mixing the composite 11 manufactured above with a solid electrolyte 12, a linear conductive material 13, a binder, etc. The method of obtaining the starting material is not particularly limited. For example, a slurry-type starting material may be obtained by adding the composite 11, the solid electrolyte 12, the linear conductive material 13, and the binder to a solvent that does not react with each component and performing stirring.

The specific method of forming the electrode 10 is not particularly limited. For example, the electrode 10 may be manufactured by applying the slurry-type starting material onto a substrate and drying the same.

The solid electrolyte layer 20 may have a sheet shape with at least two opposing major surfaces. Each of the two major surfaces may include not only a mathematical plane but also a certain curved surface in part, and may exhibit irregularities formed during the formation of the solid electrolyte layer 20. In this sense, the sheet shape is not limited to a relatively thin cuboid.

In the sheet-shaped solid electrolyte layer 20, the distance between two opposing major surfaces may be the thickness of the solid electrolyte layer 20. The length of the solid electrolyte layer 20 in the first direction (e.g., width direction) perpendicular to the thickness direction is greater than the thickness. Also, the length of the solid electrolyte layer 20 in the second direction (e.g., longitudinal direction) perpendicular to the thickness direction and the first direction is greater than the thickness.

The thickness of the solid electrolyte layer 20 is not particularly limited, but may be 1 μm to 100 μm. The thickness of the solid electrolyte layer 20 may indicate an average value when a measurement target is measured at 5 points.

The solid electrolyte layer 20 may include a solid electrolyte with lithium ion conductivity and a binder.

The solid electrolyte may be the same as or different from the solid electrolyte included in the electrode 10. The solid electrolyte may include at least one selected from the group consisting of an oxide-based solid electrolyte, a sulfide-based solid electrolyte, and combinations thereof. Also, the solid electrolyte may be crystalline, amorphous, or in a mixed state thereof. The oxide-based solid electrolyte and the sulfide-based solid electrolyte are as described above.

The binder may be the same as or different from the binder included in the electrode 10. Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder may exist in a granular or linear form in the solid electrolyte layer 30.

A better understanding of the present disclosure may be obtained through the following examples. These examples are merely set forth to illustrate the present disclosure, and are not to be construed as limiting the scope of the present disclosure.

### Preparation Example 1

A composite according to the present disclosure was manufactured by mixing an anode active material and a spherical conductive material with the following specifications using a resonance vibration mixer.
Type of anode active material: silicon particles
Specific surface area of anode active material: About 2 m²/g
Type of spherical conductive material: carbon black
Specific surface area of spherical conductive material: About 65.5 m²/g
Mass ratio of anode active material to spherical conductive material: 10:0.772
Resonant vibration mixer: LMTech (LabRAM™), gravitational acceleration of 80G, gravitational acceleration application time of 15 minutes
Mass ratio of ball to sample: 4:1

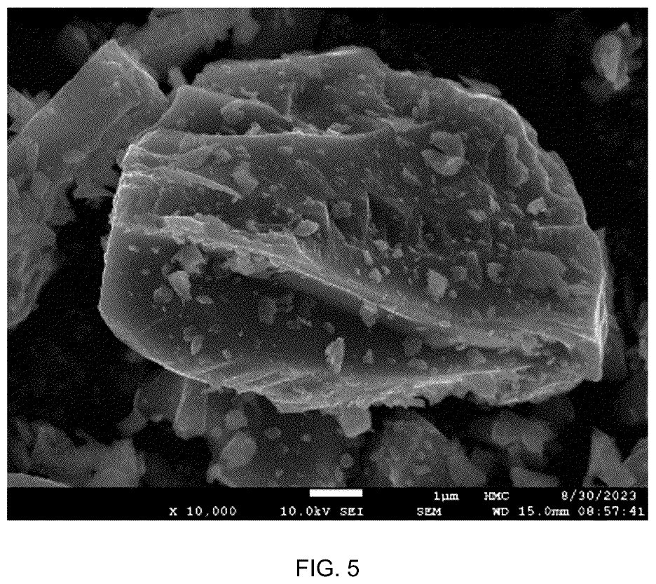

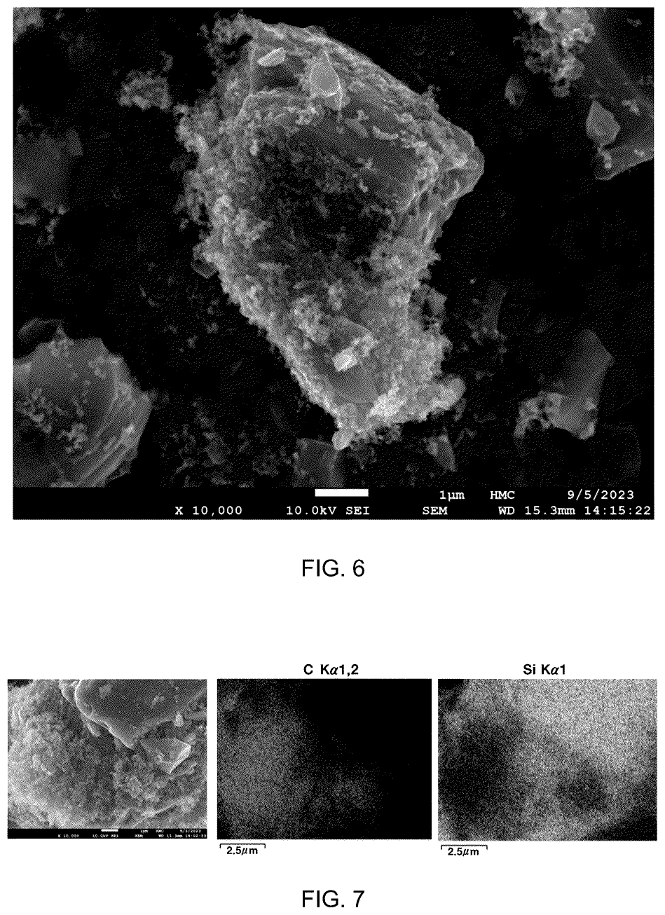

FIG. 5 shows an SEM image of the anode active material used in Preparation Example 1. FIG. 6 shows an SEM image of the composite according to Preparation Example 1. Comparing FIGS. 5 and 6, the spherical conductive material was attached well to the surface of the anode active material. FIG. 7 shows transmission electron microscope/energy-dispersive X-ray spectroscopy (TEM-EDS) images of the composite according to Preparation Example 1. Referring thereto, the spherical carbon material was evenly dispersed without completely covering the surface of silicon as the anode active material therewith.

### Example 1

A composite was manufactured by mixing an anode active material and a spherical conductive material with specifications as shown in Table 1 below using a resonance vibration mixer.

A starting material was prepared by mixing the composite, a sulfide-based solid electrolyte having an argyrodite-based crystal structure, a linear conductive material, a binder, and a solvent, and the starting material was applied onto a substrate, thus manufacturing an anode. The loading amount of the anode active material was adjusted to 3.7 mg/cm².

A slurry was prepared by mixing NCM 811 (LiNi_{0.8}Co_{0.1}Mn_{0.1}O₂) as a cathode active material, a sulfide-based solid electrolyte having an argyrodite-based crystal structure, a conductive material, a binder, and a solvent, and the slurry was applied onto a substrate, thus manufacturing a cathode. The loading amount of the cathode active material was adjusted to 24 mg/cm².

A slurry was prepared by mixing a sulfide-based solid electrolyte having an argyrodite-based crystal structure, a binder, and a solvent, and the slurry was applied onto a substrate, thus manufacturing a solid electrolyte layer in the form of a self-standing film. The thickness of the solid electrolyte layer was about 40 μm.

An all-solid-state battery was obtained by stacking the anode, the solid electrolyte layer, and the cathode in the order shown in FIG. 1. The N/P ratio of the all-solid-state battery was about 1.2.

### Comparative Example 1

Without manufacturing a composite, a starting material was prepared by mixing an anode active material, a spherical conductive material, a sulfide-based solid electrolyte having an argyrodite-based crystal structure, a linear conductive material, a binder, and a solvent, and the starting material was applied onto a substrate, thus manufacturing an anode. The anode active material and the spherical conductive material were the same as in Example 1 and were used in the same amounts.

Otherwise, an all-solid-state battery was manufactured using the same materials and methods as in Example 1.

TABLE 1

| | | | | Comparative |
|---|---|---|---|---|
| Items | | | Example 1 | Example 1 |
| Composite | Specific surface | Spherical conductive | 65.5 | — |
| | area [m²/g] | material (a) | | |
| | | Anode active | 2 | 2 |
| | | material (c) | | |
| | Amount [wt %] | Spherical conductive | 3.5 | — |
| | | material (b) | | |
| | | Anode active | 45.35 | 45.35 |
| | | material (d) | | |

| | (axb)/(cxd) | 2.53 | — |
|---|---|---|---|
| Amount of spherical conductive material [wt %] | | —¹⁾ | 3.5 |
| Amount of linear conductive material [wt %] | | 3.5 | 3.5 |
| Cell | Initial efficiency [%] | 93.2 | 85.1 |
| characteristics | 0.2C discharge capacity [mAh/g] | 188.1 | 171.5 |
| | DCIR [Ω] | 17.5 | 22.4 |
| | Capacity retention @50 cycle [%] | 94.4 | 85.1 |

¹⁾In Example 1, since the spherical conductive material is included in the composite, the amount is not described in the relevant column.

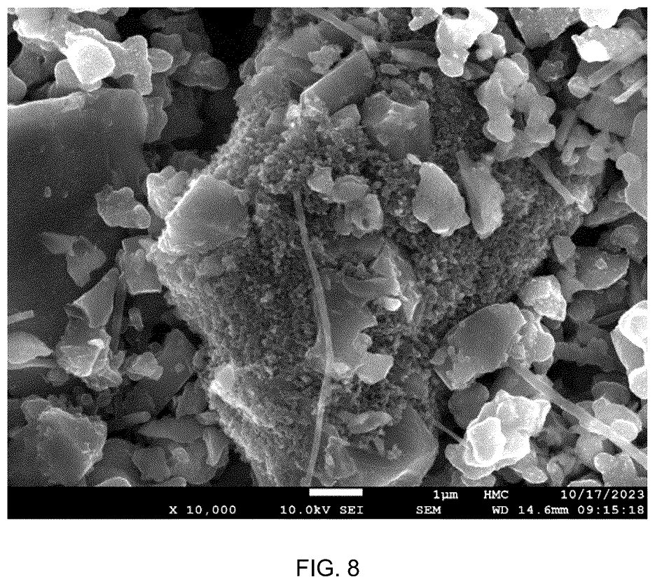

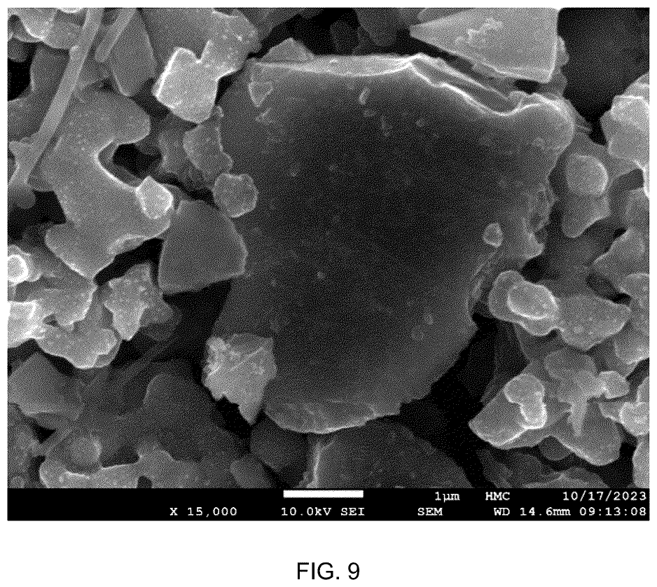

FIG. 8 shows an SEM image of the anode of the all-solid-state battery according to Example 1. FIG. 9 shows an SEM image of the anode of the all-solid-state battery according to Comparative Example 1. Comparing FIGS. 8 and 9, the anode of Example 1 was configured such that the spherical conductive material was attached to the surface of the anode active material and was evenly dispersed. In contrast, in Comparative Example 1, the spherical conductive material and the linear conductive material were not visible due to simple mixing. This suggests a likelihood of conductive material aggregation in the anode of Comparative Example 1, resulting in excess conductive material.

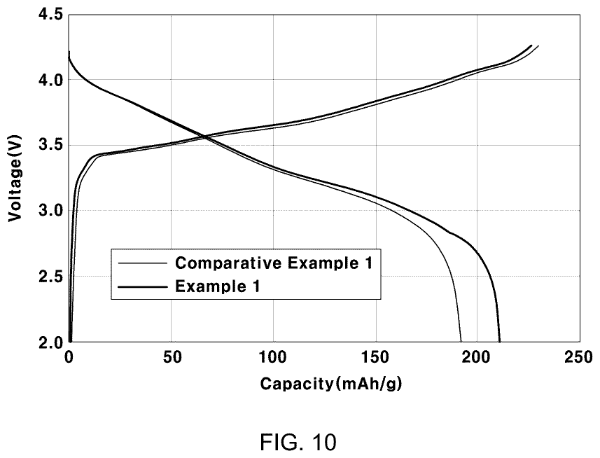

FIG. 10 shows initial performance of the all-solid-state batteries according to Example 1 and Comparative Example 1. Table 1 shows the cell characteristics of these batteries. Referring thereto, Example 1, in which the composite was formed, outperformed Comparative Example 1 in terms of initial efficiency, discharge capacity, DCIR, and capacity retention.

### Examples 2 and 3

Respective all-solid-state batteries were manufactured using the same materials and methods as in Example 1, with the exception that the anode was manufactured with specifications shown in Table 2 below.

### Comparative Examples 2 and 3

Respective all-solid-state batteries were manufactured using the same materials and methods as in Example 1, with the exception that the anode was manufactured with specifications shown in Table 2 below.

TABLE 2

| | | | Comparative | | | | Comparative |
|---|---|---|---|---|---|---|---|
| | | | Example | Example | Example | Example | Example |
| Items | | | 2 | 1 | 2 | 3 | 3 |
| Composite | Specific | Spherical | 65.5 | 65.5 | 65.5 | 65.5 | 65.5 |
| | surface | conductive | | | | | |
| | area | material | | | | | |
| | [m²/g] | (a) | | | | | |
| | | Anode | 2 | 2 | 2 | 2 | 2 |
| | | active | | | | | |
| | | material | | | | | |
| | | (c) | | | | | |
| | Amount | Spherical | 4 | 3.5 | 2 | 1.5 | 0.5 |
| | [wt %] | conductive | | | | | |
| | | material | | | | | |
| | | (b) | | | | | |
| | | Anode | 45.35 | 45.35 | 45.35 | 45.35 | 45.35 |
| | | active | | | | | |
| | | material | | | | | |
| | | (d) | | | | | |

| | | | | | | |
|---|---|---|---|---|---|---|
| | (axb)/(cxd) | 2.89 | 2.53 | 1.44 | 1.08 | 0.36 |
| Cell | Initial efficiency | 84.2 | 93.2 | 90.7 | 92.2 | 88.5 |
| characteristics | [%] | | | | | |
| | 0.2C discharge | 164.7 | 188.1 | 185.2 | 183.5 | 168.6 |
| | capacity [mAh/g] | | | | | |
| | DCIR [Ω] | 23.7 | 17.5 | 18.2 | 21.6 | 24.6 |
| | Capacity retention | 73.9 | 94.4 | 93.2 | 90.8 | 85.1 |
| | @50 cycle [%] | | | | | |

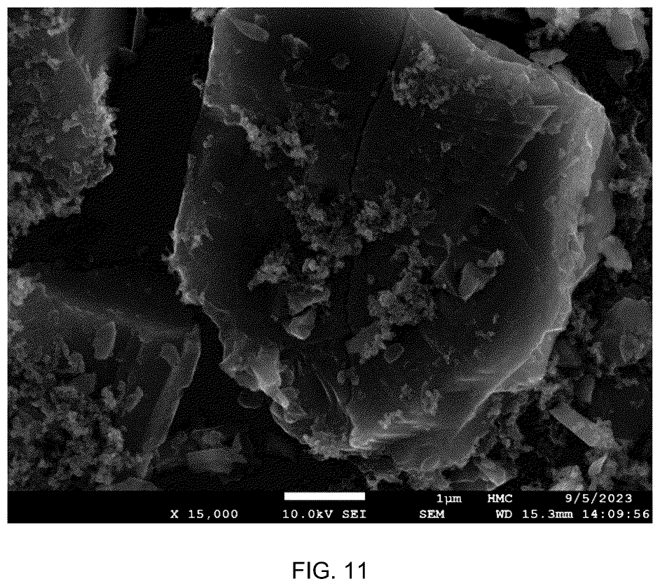

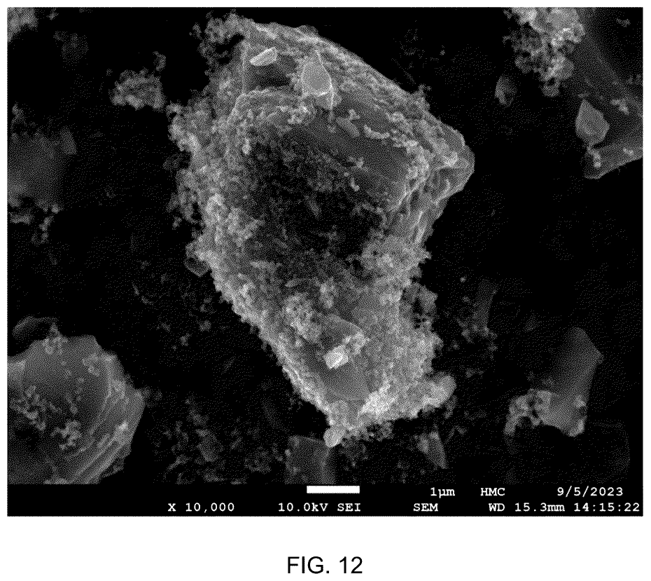

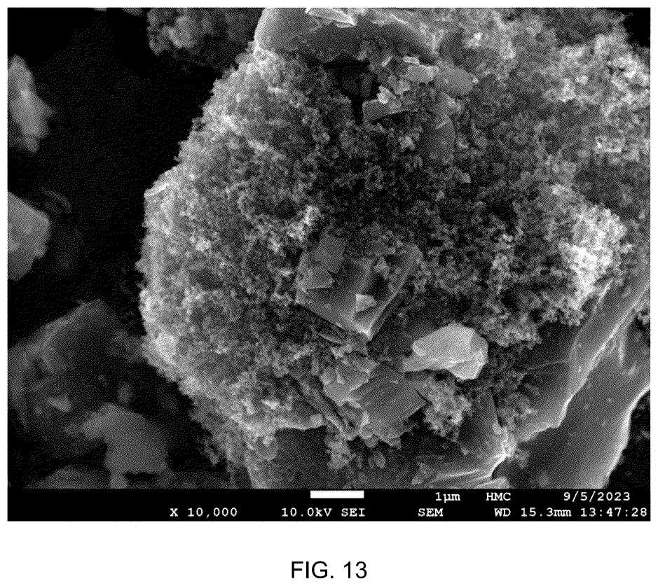

FIG. 11 shows an SEM image of the composite according to Comparative Example 3, while FIG. 12 shows an SEM image of the composite according to Example 1. Additionally, FIG. 13 shows an SEM image of the composite according to Comparative Example 2. Referring to FIG. 11, in Comparative Example 3, the value of (a×b)/(c×d) was small, so the spherical conductive material was not attached well to the surface of the anode active material. Referring to FIG. 13, in Comparative Example 2, the value of (a×b)/(c×d) was large, so the spherical conductive material was excessively attached to the surface of the anode active material.

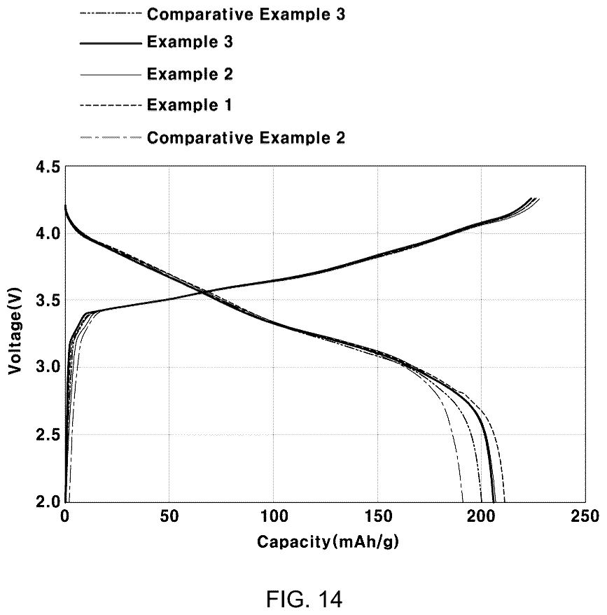

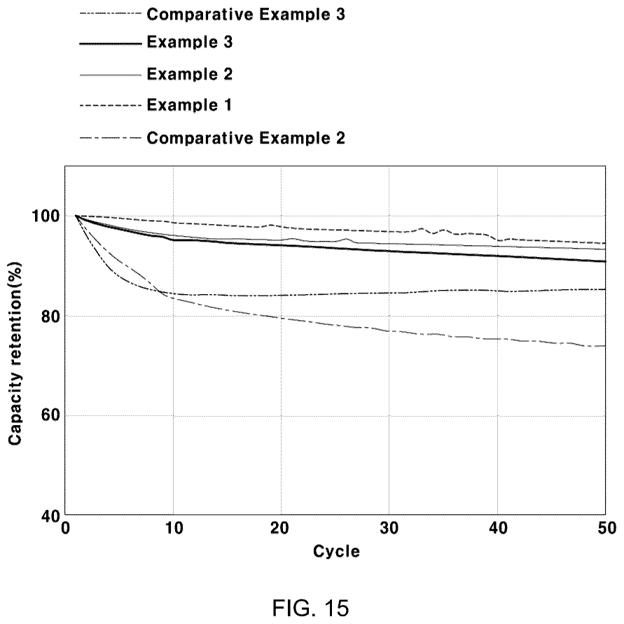

FIG. 14 shows the initial performance of the all-solid-state batteries according to Examples 1 to 3, Comparative Example 2, and Comparative Example 3. FIG. 15 shows the capacity retention of the all-solid-state batteries according to Examples 1 to 3, Comparative Example 2, and Comparative Example 3. Table 2 shows the cell characteristics of the all-solid-state batteries according to Examples 1 to 3, Comparative Example 2, and Comparative Example 3. Referring thereto, Examples 1 to 3 in which the value of (a×b)/(c×d) value fell in the range from greater than 1 to less than 2.8 outperformed Comparative Examples 2 and 3 in terms of initial efficiency, discharge capacity, DCIR, and capacity retention.

According to the present disclosure, an electrode for an all-solid-state battery with excellent dispersibility of a conductive material and a method of manufacturing the same can be provided.

According to the present disclosure, an electrode for an all-solid-state battery with a small amount of excess conductive material and a method of manufacturing the same can be provided.

The effects of the present disclosure are not limited to the above-mentioned effects. It should be understood that the effects of the present disclosure include all effects that can be inferred from the description of the present disclosure.

As the examples of the present disclosure have been described in detail above, the scope of the present disclosure is not limited to the aforementioned examples, and various modifications and improvements made by those skilled in the art using the basic concept of the present disclosure defined in the following claims are also within the scope of the present disclosure.

What is claimed is:

1. An electrode for an all-solid-state battery, comprising:
a composite comprising an electrode active material and a spherical conductive material associated with the electrode active material;
a solid electrolyte; and
a linear conductive material.

2. The electrode of claim 1, wherein the composite satisfies Equation 1 below:
$$1 < ( a \times b ) / ( c \times d ) < 2.8 \qquad [ Equation 1 ]$$
wherein in Equation 1, a is a specific surface area [m²/g] of the spherical conductive material, b is an amount [wt %] of the spherical conductive material in the electrode, c is a specific surface area [m²/g] of the electrode active material, and d is an amount [wt %] of the electrode active material in the electrode.

3. The electrode of claim 1, wherein the electrode active material comprises a cathode active material or an anode active material.

4. The electrode of claim 3, wherein the cathode active material comprises a lithium transition metal oxide.

5. The electrode of claim 3, wherein the cathode active material is coated with an alkali metal oxide.

6. The electrode of claim 3, wherein the anode active material is a composite of the carbon active material and the metal active material.

7. The electrode of claim 6, wherein the carbon active material comprises graphite.

8. The electrode of claim 6, wherein the metal active material comprises indium (In), aluminum (Al), silicon (Si), tin (Sn), or an alloy containing at least one thereof.

9. The electrode of claim 1, wherein the solid electrolyte comprises a sulfide-based solid electrolyte.

10. The electrode of claim 1, wherein the linear conductive material electrically connects:
any one composite to another adjacent composite;
any one composite to any one solid electrolyte; and
any one solid electrolyte to another adjacent solid electrolyte.

11. The electrode of claim 1, comprising:
about 40 wt % to about 70 wt % of the electrode active material;
about 1 wt % to about 10 wt % of the spherical conductive material;
about 20 wt % to about 50 wt % of the solid electrolyte; and
about 1 wt % to about 10 wt % of the linear conductive material.

12. A method of manufacturing an electrode for an all-solid-state battery, the method comprising:
manufacturing a composite comprising an electrode active material and a spherical conductive material attached to a surface of the electrode active material by mixing the electrode active material and the spherical conductive material;
preparing a starting material by mixing the composite, a solid electrolyte, and a linear conductive material; and
forming an electrode using the starting material.

13. The method of claim 12, wherein manufacturing the composite comprises manufacturing the composite by mixing the electrode active material and the spherical conductive material using a resonance vibration mixer.

14. The method of claim 12, wherein manufacturing the composite comprises applying a resonance vibration frequency ranging from greater than about 0 Hz to less than about 100 Hz to the electrode active material and the spherical conductive material.

15. The method of claim 12, wherein manufacturing the composite comprises mixing the electrode active material and the spherical conductive material by applying a gravitational acceleration of about 20 G to about 80 G thereto.

16. The method of claim 12, wherein manufacturing the composite comprises mixing the electrode active material and the spherical conductive material by applying gravitational acceleration thereto for a period of time ranging from greater than about 2 minutes to less than about 20 minutes.

17. The method of claim 12, wherein the composite satisfies Equation 1 below:
$$1 < ( a \times b ) / ( c \times d ) < 2.8 \qquad [ Equation 1 ]$$
wherein in Equation 1, a is a specific surface area [m²/g] of the spherical conductive material, b is an amount [wt %] of the spherical conductive material in the electrode, c is a specific surface area [m²/g] of the electrode active material, and d is an amount [wt %] of the electrode active material in the electrode.

18. The method of claim 12 wherein the solid electrolyte comprises a sulfide-based solid electrolyte.

19. The method of claim 12, wherein the linear conductive material in the electrode electrically connects:
any one composite to another adjacent composite;
any one composite to any one solid electrolyte; and
any one solid electrolyte to another adjacent solid electrolyte.

20. The method of claim 12, wherein the electrode comprises:
about 40 wt % to about 70 wt % of the electrode active material;
about 1 wt % to about 10 wt % of the spherical conductive material;
about 20 wt % to about 50 wt % of the solid electrolyte; and
about 1 wt % to about 10 wt % of the linear conductive material.
